(19) United States
(12) Patent Application Publication
(10) Pub. No.: US 2015/0041075 A1
(43) Pub. Date: Feb. 12, 2015

(54) Safety Gate and Extension, Retraction, and Lock Mechanism

(71) Applicant: William A. Henderson, Holden, MA (US)

(72) Inventor: William A. Henderson, Holden, MA (US)

(21) Appl. No.: 13/961,183

(22) Filed: Aug. 7, 2013

(51) Int. Cl. E06B 11/02; E06B 9/80; E06B 11/04; E06B 9/60

(52) U.S. Cl. CPC E06B 11/026; E06B 9/60; E06B 9/80; E06B 11/04; E06B 2009/801
USPC 160/245; 160/315; 242/382.5

(57) ABSTRACT

Provided is a retractable safety gate and locking mechanism for a retractable safety gate that employs a spline lock and spline geometry for extending and locking the gate in an immovable position, and an air check valve and compression spring as a time delay for retracting the gate.

### RELATED APPLICATIONS

None.

### INVENTION FIELD

The invention relates to safety gates and to lock release mechanisms for safety gates, more particularly to safety gates having a flexible, retractable, barrier.

### BACKGROUND

Retractable safety gates composed of flexible barrier sheets and. winding mechanisms are known. One example is disclosed in PCT patent publication WO94/00664, in which a roll of flexible sheet material is disposed in a housing that is vertically mounted to one side of a passageway. When the sheet material is extended across the passageway, it is received and releasably held by another housing mounted to the opposite side of the passageway. To accommodate passageways of varying widths, the barrier sheet will often be longer than the passageway it extends across. Consequently, a lock mechanism must be provided to prevent over-extension of the barrier once in position in the passageway. PCT patent publication. WO94/00664 discloses a lock mechanism that is composed of a plate and a key pin that is introducible into a selected one of a plurality of locking holes in the plate. U.S. Pat. No. 7,219,709 discloses a retractable safety gate having a spring-loaded ratchet and pawl mechanism to lock the barrier in the extended position. U.S. Pat. No. 7,178,792 discloses adjustable width safety gate having an electrically operable locking mechanism. U.S. Pat. No. 6,907,914 discloses a rotating catch wheel that cooperates with a pinned driver locking and. unlocking mechanism for a safety gate. U.S. Pat. No. 6,435,250 discloses a retractable safety gate having a clutch and stop mounted on a spool for locking the barrier in its extended position, U.S. Pat. No. 5,690,317 discloses a retractable safety gate having a spring mounted roller mechanism that is automatically locked against rewinding of the barrier by means of a ratchet and pawl mechanism. United States Patent Publication No. 2011/088323 discloses a retractable safety gate locking mechanism that is composed of a release wheel including a cylinder and a cam, a spring-loaded lock actuator movable by rotation of the cam, a toothed member that engages and disengages with the lock actuator, and a timer operatively connected to the release wheel.

### INVENTION SUMMARY

A releasable locking mechanism for a retractable safety gate is provided. The gate itself is composed of a flexible barrier sheet windably disposed about a substantially hollow spool and capable of extension from and retraction onto the spool. The locking mechanism is composed of a winding spring operatively connected to the bottom end of the spool. The winding spring applies continuous torque on the spool and is able to retract the barrier when in its extended position across a passageway. At the other, uppermost, end of the spool is a cap mounted on the spool in a sealed manner. The interior of the cap is formed with interiorly disposed angular teeth that extend downward vertically and the top of the cap has an opening in which a lock release, in the form of a depressible button, is disposed.

Within the cap, a cylindrical spline lock is rotatably attached to the top of the spool. The spline lock is formed with an angular toothed surface disposed and arranged to engage and disengage with the cap teeth to prevent rotation in one rotational direction and permit rotation in the opposite rotational direction. A spline geometry is disposed within the uppermost portion of the spool and is operatively connected with the spline lock to move the spline lock axially in relation to the spool with the application of pressure on the lock release. Time delay means comprising a compression spring is positioned within the cap and surrounding the spline lock and a one-way air check valve is mounted in the spline lock so that when the compression spring is compressed by a force imposed on the lock release, air is forced through the check valve and blocks airflow into the cap when the force on the lock release and compression spring is removed.

The mechanism is intended for use in a retractable safety gate, and a retractable safety gate is also provided. The gate includes two gateposts and a flexible barrier sheet that is extensible between the two gateposts and windably disposed about a substantially hollow spool. The gate includes the locking mechanism as defined above that is mounted on the uppermost portion of the spool in an engaged manner. The spool and locking mechanism are disposed within a housing that has a longitudinal slit for permitting extension and retraction of the barrier sheet within the housing and about the spool. The housing is slidably mountable on one of the gateposts. The extending edge of the barrier sheet is formed with an engagement head and the other gatepost is formed to removably receive the engagement head to temporarily position the barrier across the passageway. The spline lock teeth and the cap teeth are angularly formed such that they act in one direction only but allow for movement in the opposite direction. The teeth are kept engaged by means of the lock spring that continuously applies an upward force onto the spline lock, which restricts the spool from unwinding.

When the lock release is pressed by the user, the compression spring compresses and pushes downward the spline lock, which disengages the spline lock teeth from the cap teeth. There is a body of air between the lock release and the cap that is a substantially sealed volume that compresses when the lock release is depressed. The volume of air is forced through the air check valve that is mounted in the spline lock. The air check valve allows the air to flow outside the sealed volume and displace the lock release rapidly but does not allow air to flow back in. When the force on the lock release is removed by the user, the compression spring pushes upward on the lock release and spline lock, creating a vacuum within the substantially sealed volume. Air flow into this vacuum is modulated by the dimensions of one or more spaces between the components in the housing and/or through the other components. This flow of air restricts the movement of the lock release and spline lock and slows their movement as they move back to their locked positions in which the angular teeth of the spline lock engage with the angular teeth of the cap interior. The amount of time it takes to translate back into their locked positions creates a time delay. Friction between the translating and fixed components of the mechanism adds to the time delay.

### DESCRIPTION OF THE DRAWINGS

FIG. 1 is a cross section view of the bottom of the spool of the safety gate of the invention.

FIG. 2 is a cross section view of the locking mechanism of the invention.

FIG. 3 is an expanded perspective view of the locking mechanism of the invention.

FIG. 4 is an expanded perspective view of the safety gate of the invention.

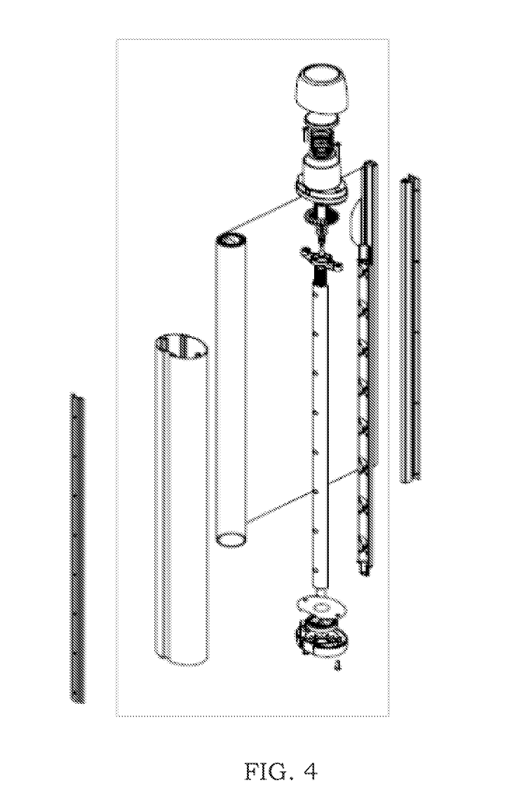

FIG. 5 is a plan view of the safety gate of the invention, with the barrier extended from its housing.

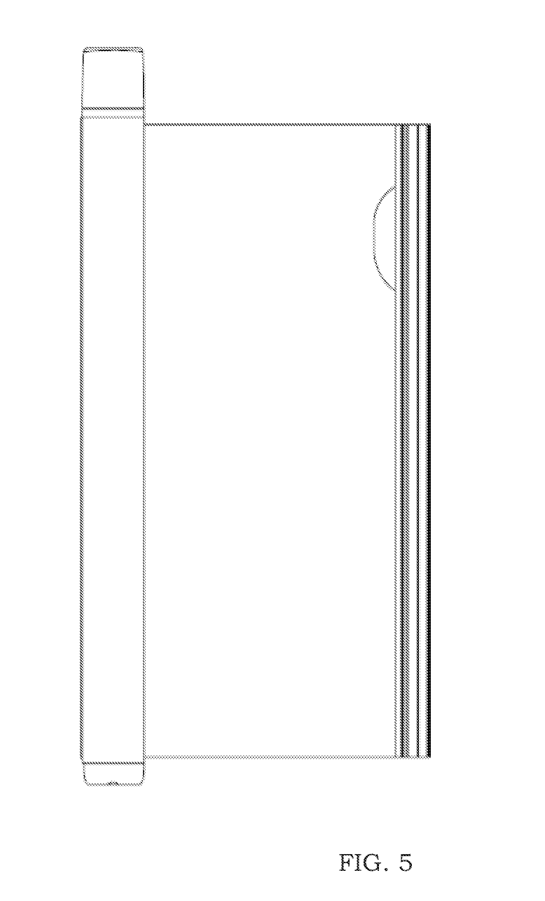

### DETAILED DESCRIPTION

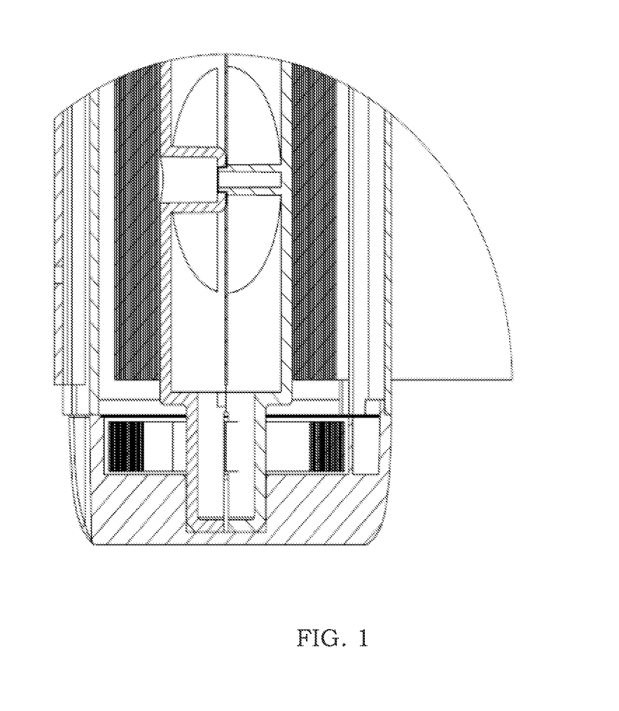

Referring now to FIG. 1, there is illustrated spool halves 5 and 7. Spool halves 5 and 7 have a series of mating holes 25 and 27 arranged longitudinally from the top of the spool halves to the bottom of the spool halves. The spool halves are connected to each other by connecting means 8. Connecting means 8 may by pins, rivets, screws and the like which are inserted into holes 25 and 27 to keep spool halves 5 and 7 together. The means by which the two halves are connected together is not critical and any suitable means will do. Alternatively, the spool may be formed as a single unitary piece either a solid or a hollow tube. At the bottom end of the spool there is disposed spool stub 6. Spool stub 6 may be formed as a unitary piece of spool halves 5 and 7. If the spool is formed of two mating pieces, one longitudinal edge of the barrier, 2, for the gate can be sandwiched between the two halves before the connecting means is inserted in the mating holes. If the spool is formed of a unitary piece, the longitudinal edge of the barrier must be affixed to the spool in another manner, by glue, tape or the like.

Winding spring cover 3 is formed to receive spool stub 6 and seat the stub by means of spool seat 4. Winding spring cover 3 is also formed to receive a winding spring, 7, which is formed with a central bore through which spool stub 6 extends. Winding spring 7 forms part of the releasable and retractable lock mechanism of the invention.

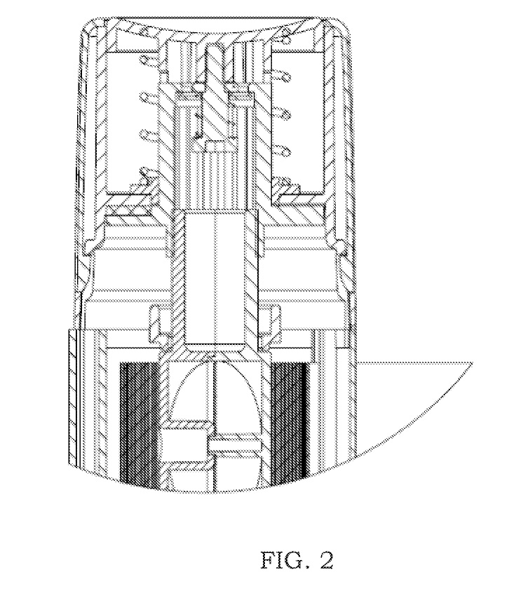

FIG. 2 illustrates the rest of the releasable lock mechanism 10 of the invention. At the other, uppermost, end of the spool is top cap 11 mounted on the spool in a sealed but removable manner. The interior of the top cap 11 is formed with interiorly disposed angular cap teeth 12 that extend. downward vertically and the top of the top cap has an opening in which a lock release 13, in the form of a depressible button, is disposed.

Within the top cap 11, a cylindrical spline lock is rotatably attached to the top of the spool. The spline lock 14 is formed with an angular toothed surface 15 disposed and arranged to engage and disengage with the interiorly disposed angular cap teeth 12 to prevent rotation in one rotational direction and permit rotation in the opposite rotational direction. A spline geometry 18 is disposed within the uppermost portion of the spool and is positioned within the spline lock and is operatively connected with it to move the spline lock axially in relation to the spool with the application of pressure on the lock release. Compression spring 16, which forms part of the time delay means, is formed and positioned to surround the spline lock and spline geometry and is engagable by lock release 13. A one-way air check valve 17 is mounted in the interior of spline lock 14 so that when the compression spring is compressed by a force imposed on lock release 13, air is forced through the check valve and blocks airflow into the cap when the force on the lock release and compression spring is removed.

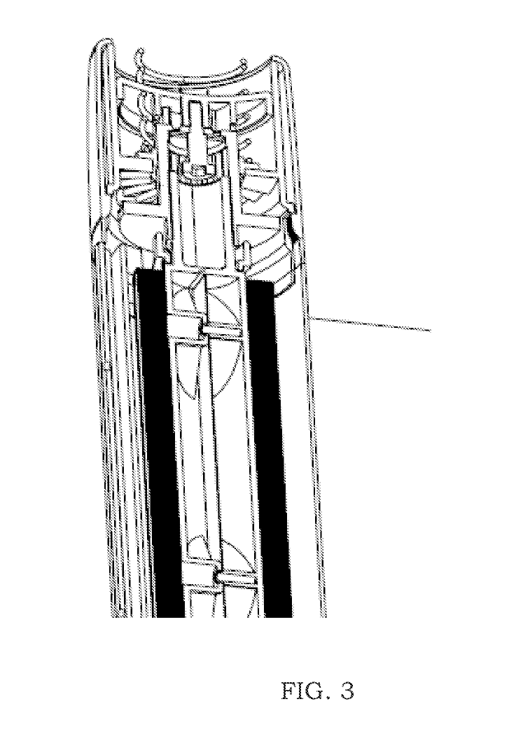

Referring now to FIG. 3, the safety gate of the invention further includes two gateposts 21 and 22 mountable on the opposing walls of a passageway and flexible barrier sheet 2 that is extensible between the two gateposts and windably disposed about the spool. The gate includes the locking mechanism as defined above that is mounted on the uppermost portion of the spool in an engaged manner. The spool is disposed within a spool housing 20 that has a longitudinal slit for permitting extension and retraction of the barrier sheet 2 within the housing and about the spool. In a position on the spool house preferably opposite the slit are gatepost engagement means 24. As shown in FIG. 3, gatepost engagement means 24 is a top to bottom vertical channel and gatepost 21 is formed with flanges that are received within the channel although other means of engagement between the spool housing and the gatepost can be readily envisioned by those of skill in the art. The spool housing 20, the winding spring cover 3 positioned below the spool housing, and a top cap housing 19 positioned above the spool housing may be formed so as to create a substantially smooth and contiguous outer surface of the safety gate. The extending edge of the barrier sheet is formed with an engagement head 23 and the other gatepost 22 is formed to removably receive the engagement head to temporarily and releasably position the barrier across the passageway. In the embodiment shown in FIG. 3, engagement head 23 snap clicks into gatepost 22 in a manner know in the art. Lock mechanism 10, including top cap 1.1, is positioned within the top cap housing 1.9 such that lock release 13 is depressible within the top cap housing. The spline lock teeth 15 and the cap teeth 12 are angularly formed such that they act in one direction only but allow for movement in the opposite direction. The teeth. are kept engaged by means of the compression spring 16 that continuously applies an upward force on the spline lock 14, which restricts the spool from unwinding.

When lock release 13 is pressed by the user, compression spring 16 compresses and pushes spline lock 14 downward, which disengages the spline lock teeth 15 from the cap teeth 12. There is a body of air between the lock release 13 and the top cap 11 that is a substantially sealed volume that compresses when the lock release is depressed. The volume of air is forced through the air check valve 17 that is mounted in the spline lock. The air check valve allows the air to flow outside the sealed volume and displace the lock release rapidly but does not allow air to flow back in. When the force on lock release 13 is removed by the user, compression spring 16 pushes upward on the lock release and spline lock 14, creating a vacuum within the substantially sealed volume. Air flow into this vacuum is modulated by the dimensions of one or more spaces 9 between the components in the housing and/or through the other components. This flow of air restricts the movement of the lock release and spline lock and slows their movement as they move back to their locked positions in which the angular teeth of the spline lock engage with the angular teeth of the cap interior. The amount of time it takes to translate back into their locked positions creates a time delay. Friction between the translating and fixed components of the mechanism adds to the time delay.

To use the safety gate of the invention, the user mounts gate posts 21. and 22 in the desired passageway (or doorway) so that they extend vertically up the walls and are positioned more or less across from each other. Next, the user slides spool housing 20 onto gate post 21. At this point, the barrier sheet is fully wound around the spool and only barrier sheet engagement head is outside of the spool housing. The user then pulls barrier sheet across the passageway and engages it with gate post 22 on the opposed side of the corridor. The engaged angular spline lock and cap teeth maintain the barrier in an unmovable position such that the barrier cannot be extended from the spool further if a pressure is applied to the barrier. To disengage the barrier, the user applies a downward force on the lock release button. When the lock release is pressed, the compression spring compresses and pushes downward the spline lock, which disengages the spline lock teeth from the cap teeth. The substantially sealed volume of air between the lock release and the cap compresses and the volume of air is forced through the air check valve that is mounted in the spline lock. The air check valve allows the air to flow outside the sealed volume and displace the lock release rapidly but does not allow air to flow back in. When the force on the lock release is removed by the user, the compression spring pushes upward on the lock release and spline lock, creating a vacuum within the substantially sealed volume. The rate of air flow back into this vacuum is dependent on and modulated by the dimensions of one or more spaces between the components in the housing, particularly the air gap between spool and the spool housing, and/or through the other components. This flow of air slows the movement of the lock release and spline lock as they move back to their locked positions in which the angular teeth of the spline lock engage with the angular teeth of the cap interior. Friction between the translating and fixed components of the mechanism adds to the time delay.

1. A releasable locking mechanism for a retractable safety gate composed of a flexible barrier sheet windably disposed about a substantially hollow spool and capable of extension from and retraction onto the spool, the locking mechanism comprising:
a winding spring operatively connected to one end of the spool to apply continuous torque on the spool;
a cap sealingly mounted on the other end of the spool, the cap having interiorly disposed angular teeth and a lock release for allowing retraction of the gate;
a cylindrical spline lock rotatably attached to the top of the spool and having an angularly toothed surface disposed and arranged to engage and disengage with the cap teeth to prevent rotation in one rotational direction and permit rotation in the opposite rotational direction, the spline lock being able to move axially in relation to the spool; and
a spline geometry disposed within the spool and operatively connected with the spline lock to move the spline lock axially in relation to the spool. with the application of pressure on the lock release.

2. The locking mechanism according to claim 1, additionally comprising time delay means for retracting the sheet onto the spool.

3. The locking mechanism according to claim 2 in which the time delay means comprises a compression spring positioned within the cap and surrounding the spline lock and a one-way air check valve mounted in the spline lock so that when the compression spring is compressed by a force imposed on the lock release, air is forced through the check valve and blocks airflow into the cap when the force on the lock release and compression spring is removed.

4. A releasable locking mechanism for a retractable safety gate composed of a flexible barrier sheet windably disposed about a substantially hollow spool and capable of extension from and retraction onto the spool, the locking mechanism comprising:
a winding spring operatively connected to one end of the spool to apply continuous torque on the spool;
a cap sealingly mounted on the other end of the spool, the cap having interiorly disposed angular teeth and a lock release for allowing retraction of the gate;
a cylindrical spline lock rotatably attached to the top of the spool and having an angular toothed surface disposed and arranged to engage and disengage with the cap teeth to prevent rotation in one rotational direction and permit rotation in the opposite rotational direction, the spline lock being able to move axially in relation to the spool;
a spline geometry disposed within the spool and operatively connected with the spline lock to move the spline lock axially in relation to the spool with the application of pressure on the lock release; and
time delay means comprising a compression spring positioned within the cap and surrounding the spline lock and a one-way air check valve mounted in the spline lock so that when the compression spring is compressed by a force imposed on the lock release, air is forced through the check valve and blocks airflow into the cap when the force on the lock release and compression spring is removed.

5. A retractable safety gate comprising:
a flexible barrier sheet extensible between two gateposts and windably disposed about a substantially hollow spool; and a locking mechanism including
a winding spring operatively connected to one end of the spool to apply continuous torque on the spool;
a cap mounted on the other end of the spool, the cap having interiorly disposed angular teeth;
a cylindrical spline lock rotatably attached to the top of the spool and having a angular toothed surface disposed and arranged to engage with the angular cap teeth to prevent rotation in one rotational direction and permit rotation in the opposite rotational direction, the spline lock being able to move axially in relation to the spool;
a spline geometry disposed within the spool and operatively connected with the spline lock to move the spline lock axially in relation to the spool.

6. The gate according to claim 5 in which the spool and locking mechanism are disposed within a housing having a longitudinal slit for permitting extension and retraction of the barrier sheet.

7. The gate according to claim 6 in which the housing is slidably mountable on one of the gate posts.

8. The gate according to claim 7 in which the extending edge of the barrier sheet is formed with an engagement head and the other gatepost is formed to removably receive the engagement head to temporarily position. the barrier across the passageway.

9. The gate according to claim 8, additionally comprising time delay means for retracting the sheet onto the spool.

10. The gate according to claim 9 in which the time delay means comprises a compression spring positioned within the cap and surrounding the spline lock and a one-way air check valve mounted in the spline lock so that when the compression spring is compressed by a force imposed on the lock release, air is forced through the check valve and blocks airflow into the cap when the force on the lock release and compression spring is removed.

11. A retractable safety gate comprising:
a flexible barrier sheet extensible between two gate posts and windably disposed about a substantially hollow spool;
and a locking mechanism including
a winding spring operatively connected to one end of the spool to apply continuous torque on the spool;
a cap mounted on the other end of the spool, the cap having interiorly disposed angular teeth;
a cylindrical spline lock rotatably attached to the top of the spool and having an angular toothed surface disposed and arranged to engage with the cap teeth to prevent rotation in one rotational direction and permit rotation in the opposite rotational direction, the spline lock being able to move axially in relation to the spool;
a spline geometry disposed within the spool and operatively connected with the spline lock to move the spline lock axially in relation to the spool; and
time delay means for retracting the sheet onto the spool.

12. The gate according to claim 11 in which the time delay means comprises a compression spring positioned within the cap and surrounding the spline lock and a one-way air check valve mounted in the spline lock so that when the compression spring is compressed by a force imposed on the lock release, air is forced through the check valve and blocks airflow into the cap when the force on the lock release and compression spring is removed.
